(19) United States
(12) Patent Application Publication
(10) Pub. No.: US 2013/0191846 A1
(43) Pub. Date: Jul. 25, 2013

(54) DATA PROCESSING METHOD, DATA PROCESSING DEVICE, AND NON-TRANSITORY COMPUTER READABLE MEDIUM STORING DATA PROCESSING PROGRAM

(71) Applicant: Takahiro Kumura, Tokyo (JP)

(72) Inventor: Takahiro Kumura, Tokyo (JP)

(73) Assignee: NEC CORPORATION, Tokyo (JP)

(21) Appl. No.: 13/824,703

(22) PCT Filed: Jun. 21, 2011
(86) PCT No.: PCT/JP2011/003532

§ 371 Date: Mar. 18, 2013

(30) Foreign Application Priority Data
Oct. 12, 2010 (JP) 2010-229784

(51) Int. Cl. G06F 9/52

(52) U.S. Cl. CPC G06F 9/526
USPC 718/106

(57) ABSTRACT

A data processing method according to the present invention includes executing a third thread for performing a series of procedures (reception, operation, storage, and transmission), in which the series of procedures includes receiving a control signal transmitted from a first thread that supplies input data, then executing an operation using the input data, storing a result of the operation to a data region specified by the control signal, and transmitting the control signal to a second thread that uses the result. This guarantees exclusive data access without locking/unlocking data at the time of executing threads with data dependency and also reduces data transfer cost.

### TECHNICAL FIELD

The present invention relates to a data processing method, a data processing device, and a non-transitory computer readable medium storing a data processing program, and particularly to a technique for parallel execution of multiple threads with data dependency.

### BACKGROUND ART

The unit of process in a parallel program is a thread. In the parallel program, multiple threads operate in parallel at the same time. The parallel program operates by cooperation of these threads to perform processes. The thread uses shared data in a shared memory accessible to other threads in order to cooperate and operate with other threads. The shared data is placed in the shared memory accessible to all threads. When multiple threads access the same memory region, a lock/unlock mechanism is used in general to guarantee exclusive data access. However, there are two problems in lock/unlock.

First, lock/unlock is a process that loses parallelism. The lock/unlock is usually performed to a predetermined data region including multiple pieces of data such as variables and arrays. When a certain data region is locked, only the thread that locked the data region can access the data region and other threads are not allowed to access the data region. Although it is unavoidable that the parallelism of a part of data access is lost by the lock/unlock, frequent use of the lock/unlock loses the parallelism in many data access. As a result, frequent use of the lock/unlock leads to performance degradation.

Next, the lock/unlock is a process difficult to handle well. In the case there are multiple threads dealing with multiple pieces of data, when each piece of data is locked separately, a deadlock can easily occur. The deadlock is a situation in which multiple threads compete for already obtained locks from each other, and this therefore stops the process from progressing. In order to avoid the deadlock, it is necessary to carefully determine how to use the lock/unlock mechanism depending on the usage of the data.

There is a method, as a method for avoiding the lock/unlock, that considers a data flow based on the data used by the threads and determines an execution order of the threads according to the data flow. This method controls the execution order of the threads based on data dependency indicated by the data flow. That is, the execution order of the threads is controlled in a way that after a certain thread performs an operation, a thread is executed that performs an operation using an operation result of the certain thread. The execution order control of the threads allows the threads to safely access the data and eliminates the need for data lock/unlock.

Although the method for determining the execution order of the threads based on the data flow requires the execution order control of the threads, the method needs no unsafe lock/unlock that could generate a failure. Therefore, it can be said that this method causes less failure than the method to control exclusive data access by the lock/unlock.

However, there also is an issue in the method based on the data flow. The issue is about a data exchanging method.

When the execution order of the threads is determined based on the data flow, it is common to directly pass data from a thread to another thread using inter-thread communication such as message passing. However, data transfer time can be shorter when the data is shared among threads using the shared memory than direct transfer of data between the threads. Although data exchange using the shared memory can reduce the transfer time for certain, there is a problem generated in the exclusive access to the share data. This is because that there may be simultaneous access to the shared data between the thread attempting to read the shared data and the thread attempting to change the shared data. As the data is copied in the data exchange in the inter-thread communication, each thread can exclusively access the data. On the other hand, as the data is not copied in the data exchange using the shared memory, each thread cannot exclusively access the data. Data transfer cost is high when the data is copied in regard to the transfer time and the storage region. Thus, a method is required to exchange the data efficiently between threads using the shared memory and not copying the data.

Patent Literature 1 discloses an interprocess communication program that allocates a shared memory region as a part of virtual address of a process, and establishes a thread using a head address of the allocated region as a start address of a stack used by the thread. This allows data to be referred from another process without performing a copy process for the interprocess communication and therefore achieves high-speed interprocess communication. However, Patent Literature 1 does not disclose the technique for guaranteeing exclusive data access in the shared memory region. That is, Patent Literature 1 does not disclose the technique that guarantees the exclusive data access and also reduces the data transfer cost.

Patent Literature 2 discloses a task level data driving computer composed of a token matching unit that stores a data value to a predetermined region in a storage device when an incoming token includes a data token, a processing device and a storage device that store to a queue a task that includes all data from other tasks and is executable, and a fan-out unit that transmits the token to another task. This data driving computer limits information exchange in the mutual connection network to intertask information exchange and reduces the load on a network and memory access. This data driving computer represents the intertask data and a flow of control in a graph, converts the graph into a task flow diagram, and passes the token to branches on the graph. However, as the data token including the data value is transmitted, there is a problem that the data transfer cost is high similarly as the above mentioned case.

### CITATION LIST

### Patent Literature

Patent Literature 1: Japanese Unexamined Patent Application Publication No. 2003-280930
Patent Literature 2: Japanese Unexamined Patent Application Publication No. 01-102645

### SUMMARY OF INVENTION

### Technical Problem

As explained in Background, there is an issue that the inter-thread communication and copy for data sharing increases the data transfer time.

An objective of the present invention is to provide a data processing method, a data processing device, and a non-transitory computer readable medium storing a data processing program that can guarantee exclusive data access at the time of executing threads with data dependency without locking/unlocking data while reducing data transfer cost.

### Solution to Problem

A first exemplary aspect of the present invention is a data processing method that includes executing a third thread for performing a series of procedures (reception, operation, storage, and transmission), in which the series of procedures includes receiving a control signal transmitted from a first thread that supplies input data, executing an operation using the input data, storing a result of the operation to a data region specified by the control signal, and transmitting the control signal to a second thread that uses the result.

A second exemplary embodiment of the present invention is a data processing device that includes a storage unit with a data region for storing data and an execution unit that executes a third thread for performing a series of procedures (reception, operation, storage, and transmission), in which the series of procedures includes receiving a control signal transmitted from a first thread that supplies input data, then executing an operation using the input data, storing a result of the operation to a data region specified by the control signal, and transmitting the control signal to a second thread that uses the result.

A third exemplary aspect of the present invention is a non-transitory computer readable medium storing a data processing program that operates a computer including a data region for storing data as means to execute a third thread for performing a series of procedures (reception, operation, storage, and transmission), the series of procedures including receiving a control signal transmitted from a first thread that supplies input data, then executing an operation using the input data, storing a result of the operation to a data region specified by the control signal, and transmitting the control signal to a second thread that uses the result.

### Advantageous Effects of Invention

The exemplary aspects of the present invention explained above can provide a data processing method, a data processing device, and a non-transitory computer readable medium storing a data processing program that can guarantee exclusive data access at the time of executing threads with data dependency without locking/unlocking data while reducing data transfer cost.

### BRIEF DESCRIPTION OF DRAWINGS

FIG. 1 is an overview block diagram of a data processing device according to an exemplary embodiment of the present invention;

FIG. 2 is a block diagram of a data processing device 1 according to the exemplary embodiment of the present invention;

FIG. 3 is a diagram showing a concept of parallel execution of threads according to the exemplary embodiment of the present invention;

FIG. 4 is a diagram showing a flow from start to end of the thread according to the exemplary embodiment of the present invention;

FIG. 5 is a diagram showing parameters of a channel used by a thread for signal transmission and reception;

FIG. 6 is a diagram showing a procedure for the thread to transmit a signal to another thread;

FIG. 7 is a diagram showing a procedure for a thread to receive a signal from another thread;

FIG. 8 is a diagram showing a state in which signals propagate multiple threads;

FIG. 9A is a diagram showing a state in which multiple threads operate in pipeline parallel using the data processing device according to the exemplary embodiment of the present invention;

FIG. 9B is a diagram showing a state in which multiple threads operate in pipeline parallel using the data processing device according to the exemplary embodiment of the present invention; and

FIG. 9C is a diagram showing a state in which multiple threads operate in pipeline parallel using the data processing device according to the exemplary embodiment of the present invention.

### DESCRIPTION OF EMBODIMENTS

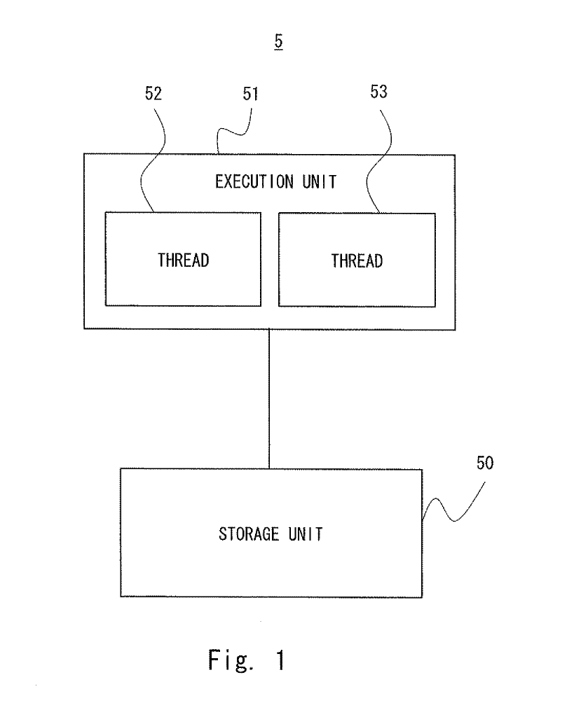

First, an overview of a data processing device 1 according to an exemplary embodiment of the present invention is explained with reference to FIG. 1. FIG. 1 is an overview block diagram of the data processing device 1 according to the exemplary embodiment of the present invention.

A data processing device 5 includes a storage unit 50 and an execution unit 51. The storage unit 50 includes multiple regions for storing data. The execution unit 51 executes multiple threads. Multiple threads have data dependency. For example, there is a relation in which a thread 53 uses an operation result of a thread 52. The execution unit 51 determines an execution order of the threads based on the data dependency.

Next, processes of the data processing device 5 according to the exemplary embodiment of the present invention are explained. In this explanation, one of two threads with data dependency shall be referred to as a first thread, and the other thread shall be referred to as a second thread. These two threads are in a relation in which the second thread uses an operation result of the first thread. The first thread 52 performs an operation and stores data, which is an operation result, to a particular region among multiple regions included in the storage unit 50. Then, the first thread 52 transmits to the second thread 53 storage notification information for notifying data storage to the storage unit 50 and storage region information indicating the region in the storage unit 50 storing the data. In response to the storage notification information from the first thread, the second thread 53 performs an operation using the data stored to the region indicated by the storage region information from the first thread 52.

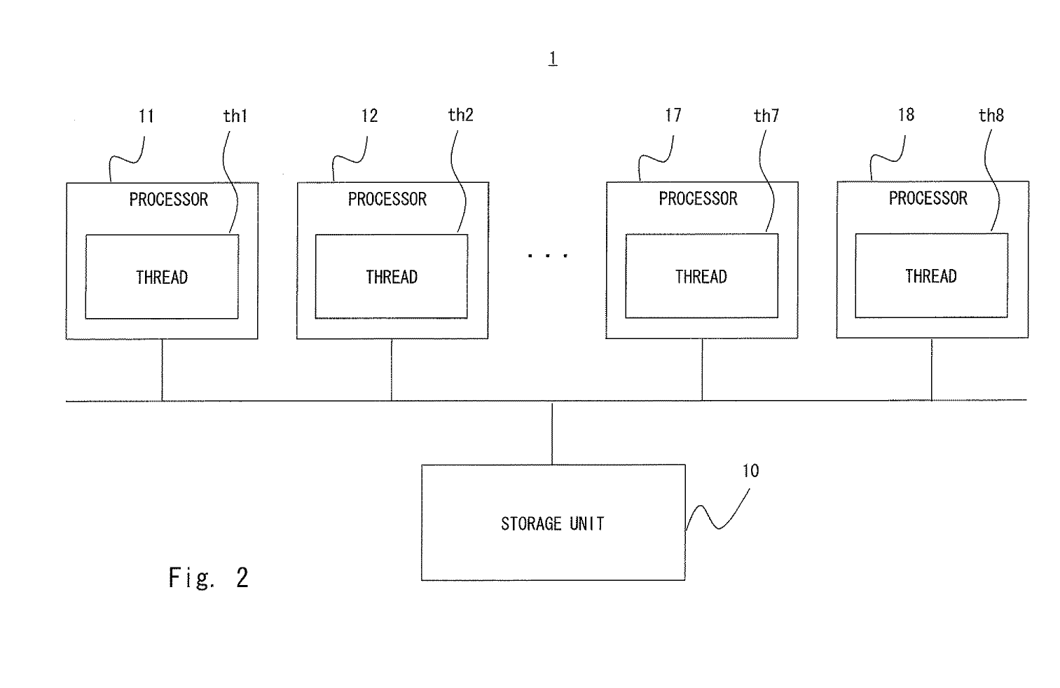

Next, the exemplary embodiment of the present invention is explained in detail with reference to the drawings. First, a configuration of the data processing device 1 according to the exemplary embodiment of the present invention is explained with reference to FIG. 2. FIG. 2 is a block diagram of the data processing device 1 according to the exemplary embodiment of the present invention.

The data processing device 1 includes a storage unit 10 and processors 11 to 18. Note that the processors 13 to 16 are not shown.

The storage unit 10 is a storage device that holds a program for driving the processors 11 to 18 and various data used by the processors 11 to 18. The exemplary embodiment of the storage unit 10 is, for example, a memory and a hard disk drive. The storage unit 10 corresponds to the storage unit 50.

The processors 11 to 18 execute threads th1 to th8. Specifically, the processor 1N executes the thread thN (N is a positive integer from 1 to 8). The processors 11 to 18 correspond to the execution unit 51. Although one thread is assigned to one processor in FIG. 2, multiple threads may be assigned to one processor. The processors 11 to 18 exchange data via the storage unit 10 while independently operating from each other.

A concept of the parallel process according to the model embodiment of the present invention is explained. This exemplary embodiment decomposes a task subjected to the parallel process into several subtasks, assigns the subtask to the thread, and executes the threads in parallel. The thread is a program that executes the subtask. In this exemplary embodiment, the execution order is determined based on the dependency of the threads at the time of parallel execution of the threads. The threads with no dependency are executed in parallel, and the threads with dependency are executed in order based on the dependency.

The dependency of the threads is equivalent to the dependency of the subtasks assigned to the threads. Further, the dependency of the subtasks is equivalent to the dependency of the data handled by the subtasks. This exemplary embodiment determines the dependency of the subtasks based on the data used by the subtasks. For example, when a subtask T2 uses an operation result R1 of a subtask T1, the subtask T2 depends on the subtask T1, and thus the subtask T2 must be executed after the subtask T1. The dependency of the subtasks is determined based on such data flow. The dependency of the subtasks represents the dependency of the threads as is.

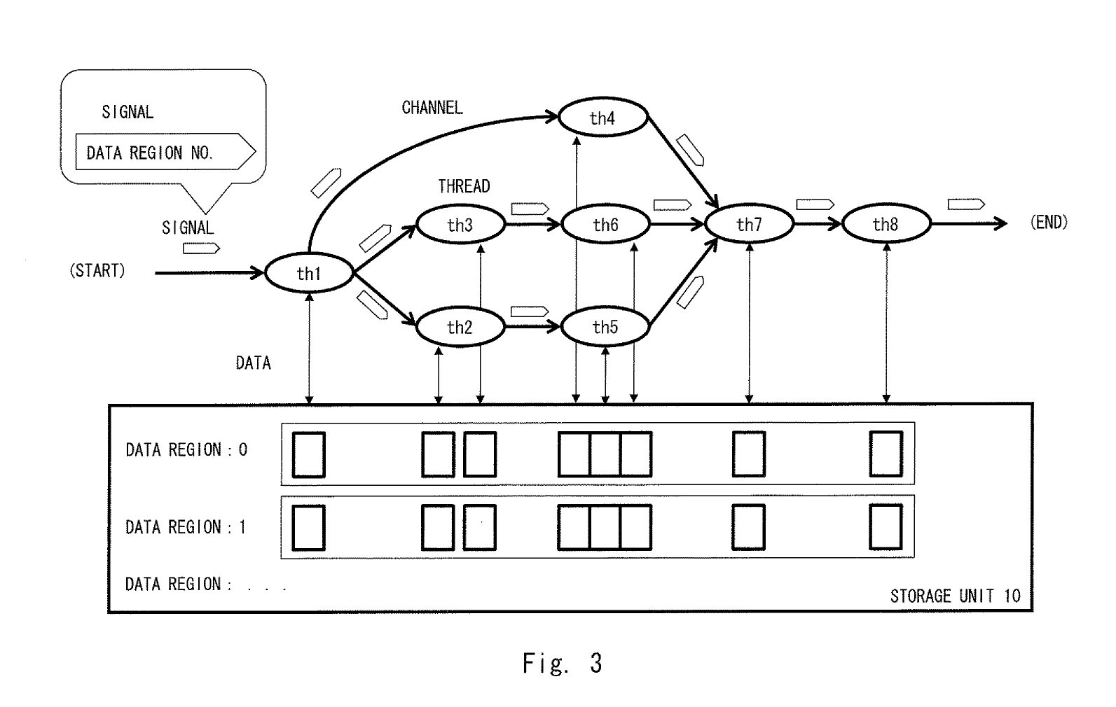

FIG. 3 is a diagram showing a concept of parallel execution of threads in this exemplary embodiment. In FIG. 3, the execution order of threads is determined in advance based on a graph structure showing the data dependency. This graph structure represents the data dependency handled by the threads and has the same structure as the data flow of the task composed of multiple subtasks. Specifically, the graph structure representing the data dependency between multiple subtasks included in the task will be a graph structure representing the data dependency between multiple threads that execute the corresponding subtasks.

The graph structure illustrating thread dependency as in FIG. 3 shows the thread of which the operation result is the data used by each thread, and the thread that uses the operation result of each thread. In FIG. 3, threads th2 to th4 use an operation result of a thread th1, a thread th5 uses an operation result of the thread th2, a thread 6 uses an operation result of the thread th3, a thread th7 uses operation results of the threads th4 and th5, and a thread th8 uses an operation result of the thread th7.

In FIG. 3, lines connecting the two threads are channels. The channel is a one-way bufferless handshake communication path between two threads with dependency. In FIG. 3, an arrow is pointed from the thread th1 to the thread th4. This indicates that the thread th4 uses the operation result of the thread th1, and a signal is transmitted from the thread th1 to the thread th4. Moreover, in the handshake communication path, after a transmission thread confirms that a reception thread received information transmitted from the transmission thread, the transmission is completed. This exemplary embodiment uses the channel to notify the thread of a start and end of execution of the subtask.

Once the execution of the subtask is completed, the thread transmits the signal through the channel to another thread. The signal is information transmitted from a thread to another thread. Signal transmission is means to notify other threads that the execution of the subtask is completed. Reception of the signal by the reception thread means that the reception thread can start executing the subtasks. In transmission and reception of the signal between threads, transmission is considered completed only when the transmission thread confirms that the signal is received by the reception thread. That is, the thread starts the process upon receipt of the signal from another thread, and when the process is completed, transmits the signal to the another thread.

The signal includes a data region number of the storage unit 10 used by the subtask assigned to the thread. The storage unit 10 has some data regions. Each data region is a region to store multiple pieces of data to be input and output to and from the subtasks of the threads th1 to th8. The data is a variable, an array and the like. Each data region has the same data structure. For example, one data region is defined as a structure. Moreover, multiple data regions are defined as an array of structures. An element number of the array will be the data region number included in the signal. The input and output data to and from the subtask is placed in the data region indicated by the data region number included in the signal among multiple data regions in the storage unit 10. The thread obtains the data required by the subtask from the data region and performs an operation using the obtained data. The thread writes the operation result of the subtask to the data region.

The thread includes in a signal to another thread the data region number included in the received signal and transmits the signal. Therefore, the data region number of the signal supplied to the thread th1, which is a starting point of FIG. 3, is transmitted to other threads th2 to th8. Further, in this exemplary embodiment, as explained later, the data region number supplied to the thread th1, which is the starting point, is switched, so that the threads operate in pipeline parallel using multiple data regions. The pipeline parallel operation of the threads can be achieved with at least two data regions.

### <From Start to End of Thread>

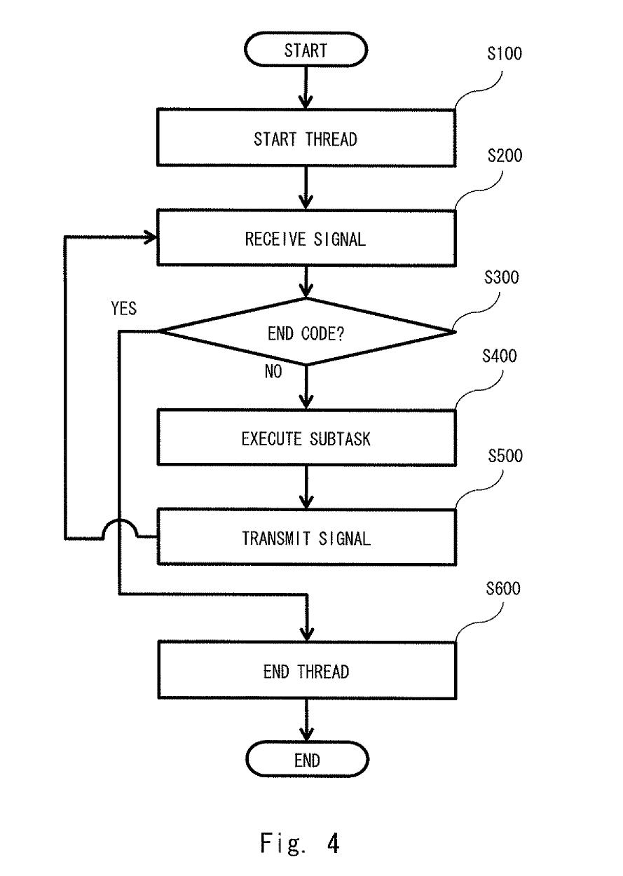

Next, a flow from start to end of a thread is explained with reference to FIG. 4. The processor (one of the processors 11 to 18) creates and starts a thread (S100). The started thread shall be thN. Hereinafter, the process executed by the thread thN shall be executed by the processor in practice.

The thread thN waits until the thread thN receives a signal from another thread with dependency (S200). When the thread thN is dependent on multiple threads, the thread thN waits until the thread thN receives signals from all those threads. When the thread thN receives the signals from all the threads on which the thread thN depends, the process proceeds to the next step S300.

The thread thN checks whether or not an end code is included in any of the received signals (S300). When the end code is included (S300:Yes), the thread thN proceeds to the step S600. When the end code is not included (S300:No), the thread thN proceeds to the step S400.

The thread thN reads a data region number Didx in the received signal, uses the data in the data region with the number Didx, and executes a subtask (S400). The thread thN writes an execution result of the subtask to the data region with the number Didx. After the execution of the subtask is completed, the thread thN proceeds to the step S500.

The thread thN transmits a signal to all the threads that use an operation result of the thread thN (S500). That is, the thread thN transmits the signal to other threads with dependency. When the signal is transmitted to all the threads that use the operation result of the thread thN, the thread thN returns to the step S200. When the end code is included in one of the signals received in the step S200 (S300:Yes), the thread thN ends the execution (S600).

Hereinafter, the signal reception in the step S200 and the signal transmission in the step S500 is explained in detail.

### <Transmission and Reception of Signal>

Below is an explanation of how a thread receives a signal. In the step S200 of FIG. 4, the thread receives a signal. In the step S500 of FIG. 4, the thread transmits a signal. In the signal transmission and reception in the steps S200 and S500, after the transmission thread confirms that the reception thread is in a state ready for reception, the transmission thread transmits the signal. Then, after the reception thread confirms that the reception thread has received the signal, the transmission thread completes the signal transmission. This is a basic procedure of signal transmission and reception in this exemplary embodiment. Below is an explanation of signal transmission and reception using polling as implementation of the steps S200 and S500.

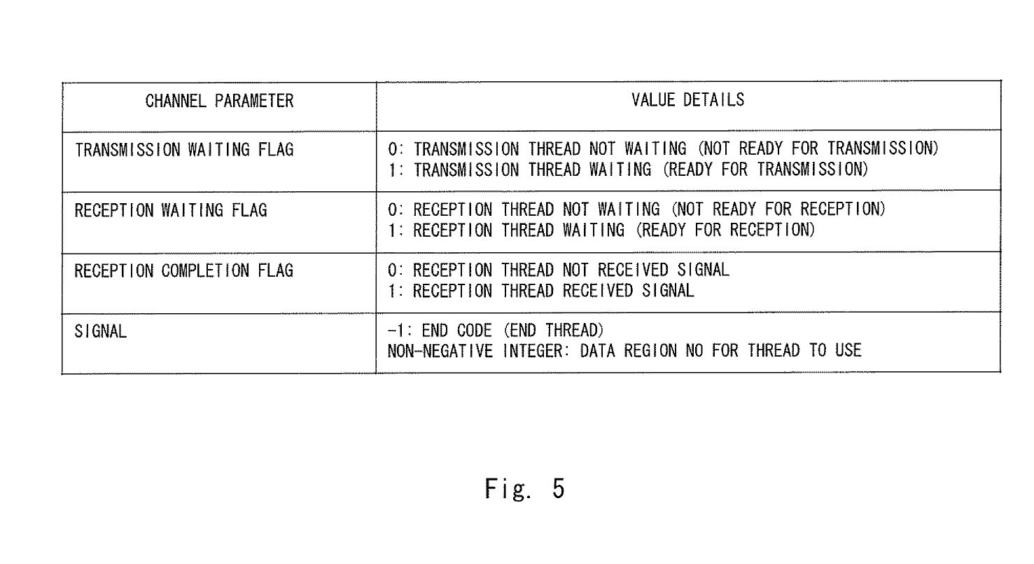

The thread controls the procedure of transmission and reception using parameters of the channel shown in FIG. 5 at the time of signal transmission and reception. The parameters of the channel include following four.

Transmission Waiting Flag

This flag indicates whether or not the thread transmitting the signal is ready for transmission. When a value of the flag is 0, it means that the transmission thread is not ready for transmission. When the value of the flag is 1, it means that the transmission thread is ready for transmission.

Reception Waiting Flag

This flag indicates whether or not the thread receiving the signal is ready for reception. When a value of the flag is 0, it means that the reception thread is not ready for reception. When the value of the flag is 1, it means that the reception thread is ready for reception.

Reception Completion Flag

This flag indicates whether or not the thread receiving the signal has received the signal. When a value of the flag is 0, it means that the reception thread has not received the signal. When the value of the flag is 1, it means that the reception thread has received the signal.

Signal

This value is transmitted by the thread. The signal with a value of −1 is the end code and indicates that the thread that received this end code will end. The signal with a non-negative integer value represents the number of data region that should be used by the thread.

The parameters of the channel are stored to the storage unit 10. For example, the storage unit 10 includes multiple regions each corresponding to the channel. Each of the multiple regions stores the parameters of the channel corresponding to the respective region. As explained later, the thread transmits and receives the signal according to a change in the parameters of the channel stored to the storage unit 10.

### <Signal Transmission Using Polling>

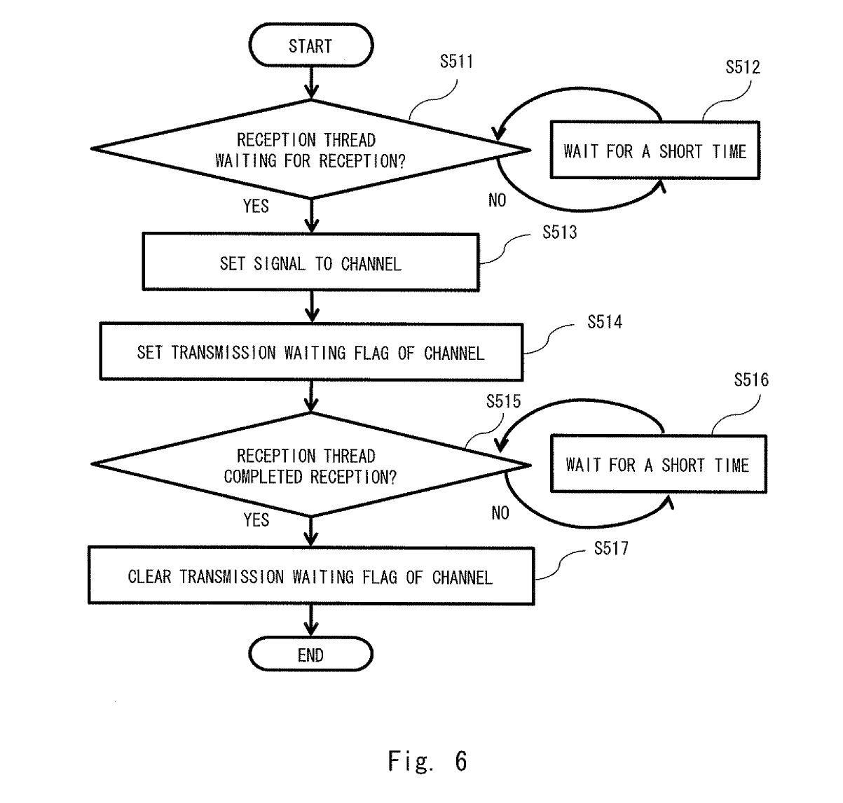

A procedure of the signal transmission using polling is explained with reference to FIG. 6. In the following explanation, a transmission thread shall be referred to as a thread S, a reception thread shall be referred to as a thread R, and a channel from the thread S to the thread R shall be referred to as a channel C.

The transmission thread S checks whether the reception thread R is waiting for reception (S511). When the reception waiting flag of the channel C is 1, the transmission thread S can determine that the thread R is waiting for reception. When the thread R is not waiting for reception (S511:No), the thread S proceeds to the step S512. After the thread S waits for a short time, the thread S returns to the step S511 again (S512). That is, the thread S repeats the step S511 and step S512 until the reception thread S enters the state of waiting for reception. In other words, the thread S performs polling until 1 is set to the reception waiting flag of the channel that associates the thread S and the thread R. When the reception thread R is waiting for reception in the step S511 (S511:Yes), the thread S proceeds to the step S513.

The thread S writes to the channel C a signal to be transmitted to the thread R (S513). The thread S sets the transmission waiting flag of the channel C to 1 (S514).

The thread S checks whether or not the reception thread R has completed the reception (S515). When the reception completion flag of the channel C is 1, the thread S can determine that the thread R has completed the reception. When the thread R has not completed the reception (S515:No), the thread S proceeds to the step S516. After the thread S waits for a short time, the thread S returns to the step S515 again (S516). That is, the thread S repeats the step S515 and the step S516 until the reception thread R completes the reception. In other words, the thread S performs polling until 1 is set to the reception completion flag of the channel that associates the thread S and the thread R. When the reception thread R has completed the reception in the step S515 (S515:Yes), the thread S proceeds to the step S517.

The thread S clears the transmission waiting flag of the channel C to 0 (S517). As described so far, the thread S uses the channel C to transmit the signal to the thread R. In this exemplary embodiment, the thread S transmits the signal to the thread R one-to-one. When the thread S transmits a signal to multiple threads, the thread S repeats the above one-to-one signal transmission for multiple times.

### <Signal Reception Using Polling>

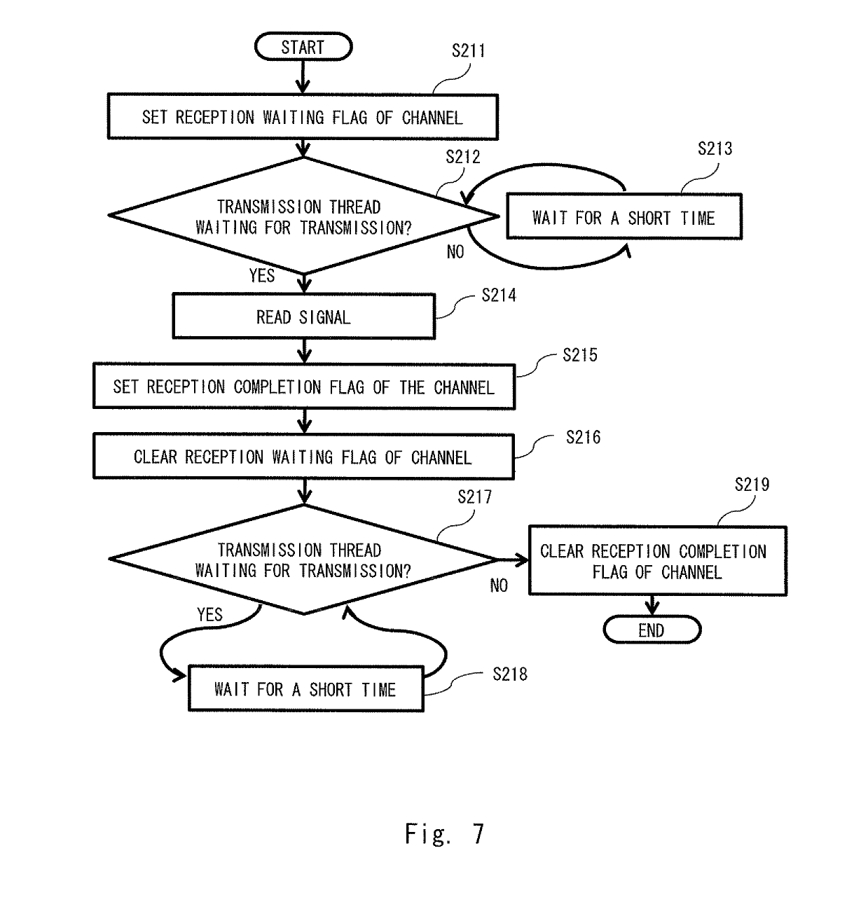

Hereinafter, a procedure of signal reception using polling is explained with reference to FIG. 7. In the following explanation, a transmission thread shall be referred to as a thread S, a reception thread shall be referred to as a thread R, and a channel from the thread S to the thread R shall be referred to as a channel C. The reception thread R sets the reception waiting flag of the channel C to 1 (S211).

The reception thread R checks whether or not the transmission thread S is waiting for transmission (S212). When the transmission waiting flag of the channel C is 1, the reception thread R can determine that the thread S is waiting for transmission. When the thread S is not waiting for transmission (S212:No), the thread R proceeds to the step S213. After the thread R waits for a short time, the thread S returns to the step S212 again (S213). That is, the thread R repeats the step S212 and step S213 until the transmission thread S enters the state of waiting for the transmission. In other words, the thread R performs polling until 1 is set to the transmission waiting flag that associates the thread R and the thread S. When the transmission thread S is waiting for transmission in the step S212 (S212:Yes), the thread R proceeds to the step S214.

The thread R reads a signal from the channel C (S214). The thread R sets the reception completion flag of the channel C to 1 (S215). The thread R clears the reception waiting flag of the channel C to 0 (S216).

The thread R checks whether or not the transmission thread S is still waiting for transmission (S217). When the transmission waiting flag of the channel C is 1, the thread R can determine that the thread S is waiting for transmission. When the transmission thread S is waiting for transmission in the step S217 (S217:Yes), the thread R proceeds to the step S218. After the thread R waits for a short time, the thread R returns to the step S217 again (S218). That is, the thread R repeats the step S217 and the step S218 until the transmission thread S is no longer in the state of waiting for transmission. In other words, the thread R performs polling until the transmission waiting flag of the channel that associates the thread R and the thread S is cleared to 0. When the transmission thread S is not waiting for transmission in the step S217 (S217:No), the thread R proceeds to the step S219.

After the thread R executes the step S215, the transmission thread S knows that the thread R has completed the reception. In response to this, the thread S clears the transmission waiting flag of the channel C to 0 (S517). Then, the thread R knows that the thread S is no longer in the state of waiting for transmission. The thread R executes the step S217 in this way. When the transmission thread S is not waiting for transmission in the step S217 (S217:No), the thread R clears the reception completion flag of the channel C to 0 (S219). As described above, the thread R uses the channel C to receive the signal from the thread S.

In this exemplary embodiment, the thread R receives the signal solely from the thread S. When the thread R receives the signal from multiple threads, the thread R repeats the one-to-one signal reception for multiple times.

The signal transmission and reception using polling has been explained so far as implementation of the steps S200 and S500. The implementation of the steps S200 and S500 is not limited to this, but can be implemented by other methods than the one described here as long as the method is based on the basic idea of signal transmission and reception described above. Specifically, the method is not limited to the above method so long as it is based on the idea that after the transmission thread confirms that the reception thread is in the state ready for reception, the transmission thread transmits the signal, and after the transmission thread confirms that the reception thread has received the signal, the transmission thread completes the signal transmission.

### <Signal Propagation>

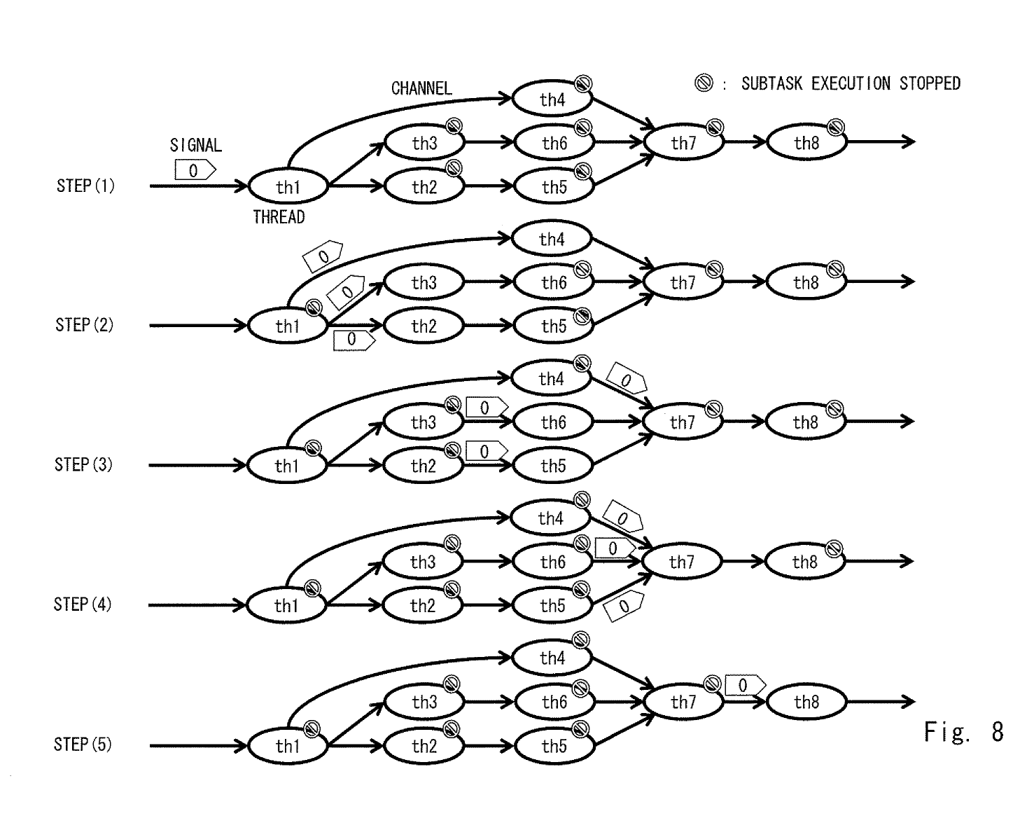

Below is an explanation of a state, with reference to FIG. 8, in which a subtask assigned to the thread is executed while signals propagate from a thread to another thread. There are eight threads from threads th1 to th8 in FIG. 8. The subtask is assigned to each thread th1 to th8. The processing time of each subtask shall be the same for the sake of simplicity.

Among the eight threads th1 to th8, the thread th1 is a thread to be a starting point, and th8 is a thread to be an ending point. Although not shown in FIG. 8, there is another thread to control start and end of the eight threads. This thread shall be referred to as a main thread. The main thread may be executed by one of the processors 11 to 18 or another processor not shown other than the processors 11 to 18. There are channels between the main thread and the thread th1, which is the starting point, and between the main thread and the thread th8, which is the ending point. The main thread uses a different region in the storage device from the data region used by the threads th1 to th8 and operates in parallel with the threads th1 to th8.

First, the main thread transmits a signal to the thread th1 to be the starting point in the step (1). At this time, the main thread shall include the data region number 0 in the signal. The thread th1 receives the signal and executes the subtask using the data region with the data region number 0. That is, the thread th1 performs an operation and stores an operation result to the data region with the data region number 0.

Next, in the step (2), the thread th1 transmits a copy of the signal received by the thread th1 to the threads th2, th3, and th4. Each of the threads th2, th3, and th4 that received the signal executes respective subtask using the data region with the data region number 0. That is, each of the threads th2 to th4 obtains the operation result of the thread th1 to be stored to the data region with the data region number 0. Then, the threads th2 to th4 each perform an operation using the obtained data and stores the operation result to the data region with the data region number 0.

Next, in the step (3), each of the threads th2, th3, and th4 transmits a copy of the signal received by the threads th2, th3, and th4 to each of the threads th5, th6, and th7, respectively. Then, each of the threads th5 and th6 that received the signal executes respective subtask using the data region with the data region number 0. That is, the thread th5 obtains the operation result of the thread th2 stored to the data region with the data region number 0. Subsequently, the thread th5 performs an operation using the obtained data and stores the operation result to the data region with the data region number 0. Moreover, the thread th6 obtains the operation result of the thread th3 to be stored to the data region with the data region number 0. The thread th6 further performs an operation using the obtained data and stores the operation result to the data region with the data region number 0. Meanwhile, since the thread th7 needs to receive not only the signal from the thread th4 but also the signals from the threads th5 and th6, the thread th7 continues to wait for the signals from the thread th5 and th6.

Next, in the step (4), each of the threads th5 and th6 transmits a copy of the signal received by the threads th5 and th6 to the thread th7. With the signals received, the thread th7 has received all the signals from the threads th4, th5, and th6 on which the thread th7 depends, the thread th7 starts executing the subtask using the data region with the data region number 0. That is, the thread th7 obtains the operation results of the threads th4 to th6 stored to the data region with the data region number 0. Subsequently, the thread th7 performs an operation using the obtained data and stores the operation result to the data region with the data region number 0.

Next in the step (5), the thread th7 transmits a copy of the signal received by the thread th7 to the thread th8. Then, the thread th8 receives the signal and starts executing the subtask using the data region with the number 0. That is, the thread th8 obtains the operation result of the thread th7 stored to the data region with the data region number 0. Then, the thread th8 performs an operation using the obtained data and stores the operation result to the data region with the data region number 0. In the course of time, the execution of the subtask is completed, and the thread th8 transmits a copy of the signal received by the thread th8 to the main thread. Upon receipt of the signal from the thread th8, which is the ending point thread, the main thread knows that the execution of all the subtasks is completed.

Although the example of FIG. 8 explained in assumption that the execution time of each subtask is the same, the execution time of the subtasks is different in general. Different execution time of the subtasks leads to different reception time of the signals in the thread that receives the signals from multiple threads. However, in this exemplary embodiment, the difference can be accepted using handshake signal transmission and reception.

The handshake signal transmission and reception is based on the idea that after the transmission thread confirms that the reception thread is in the state ready for reception, the transmission thread transmits a signal, and after the transmission thread confirms that the reception thread has received the signal, the transmission thread completes the signal transmission. That is, waiting is included in the procedure of signal transmission and reception. Therefore, even when the execution time of the subtasks and signal reception time differs, the difference can be accepted.

<Pipeline Parallel Operation>

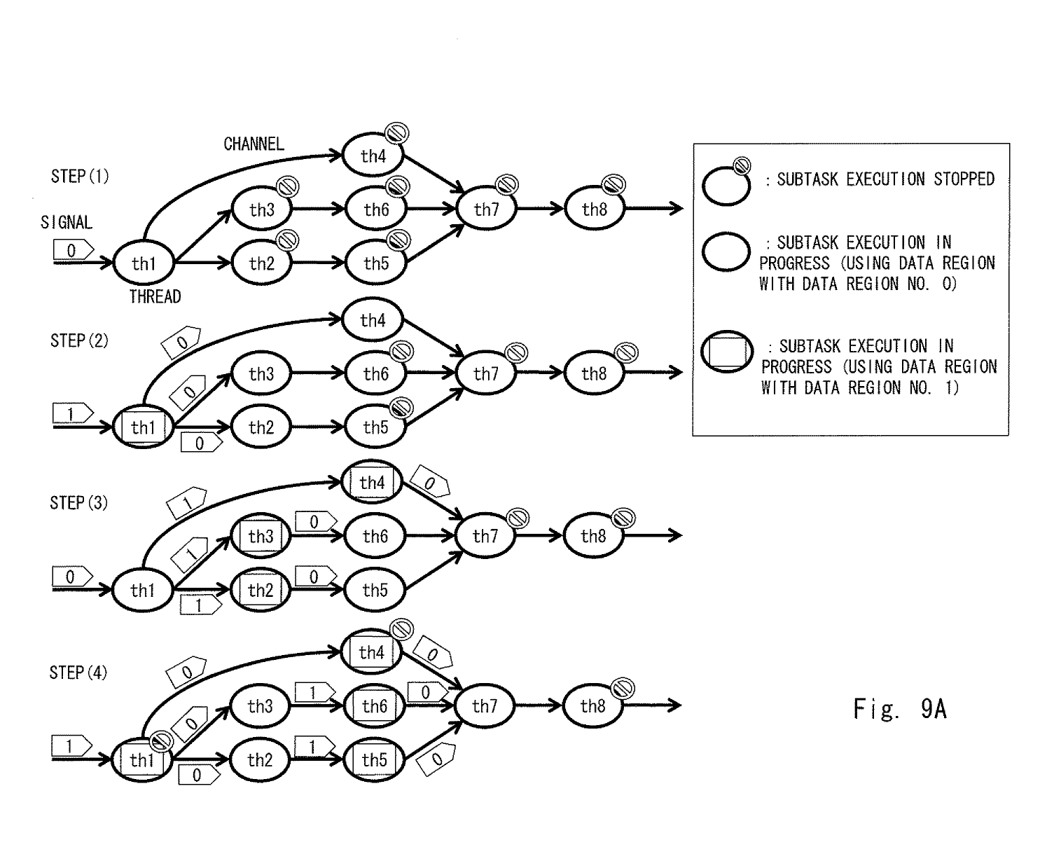

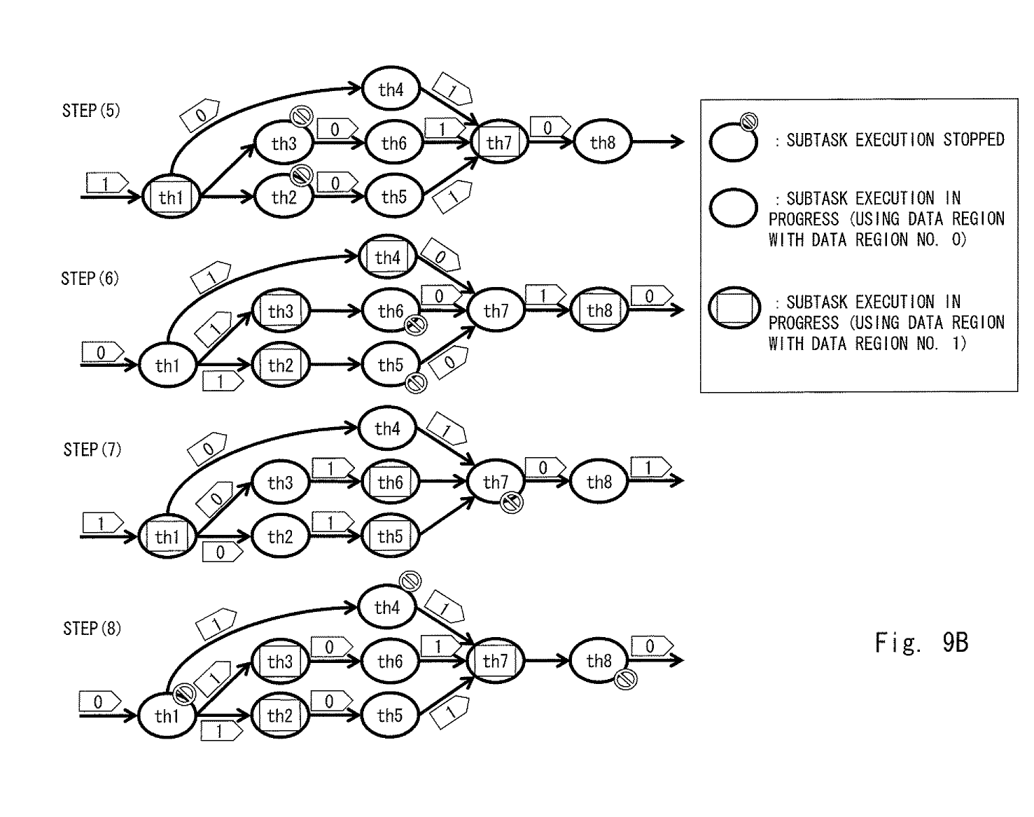

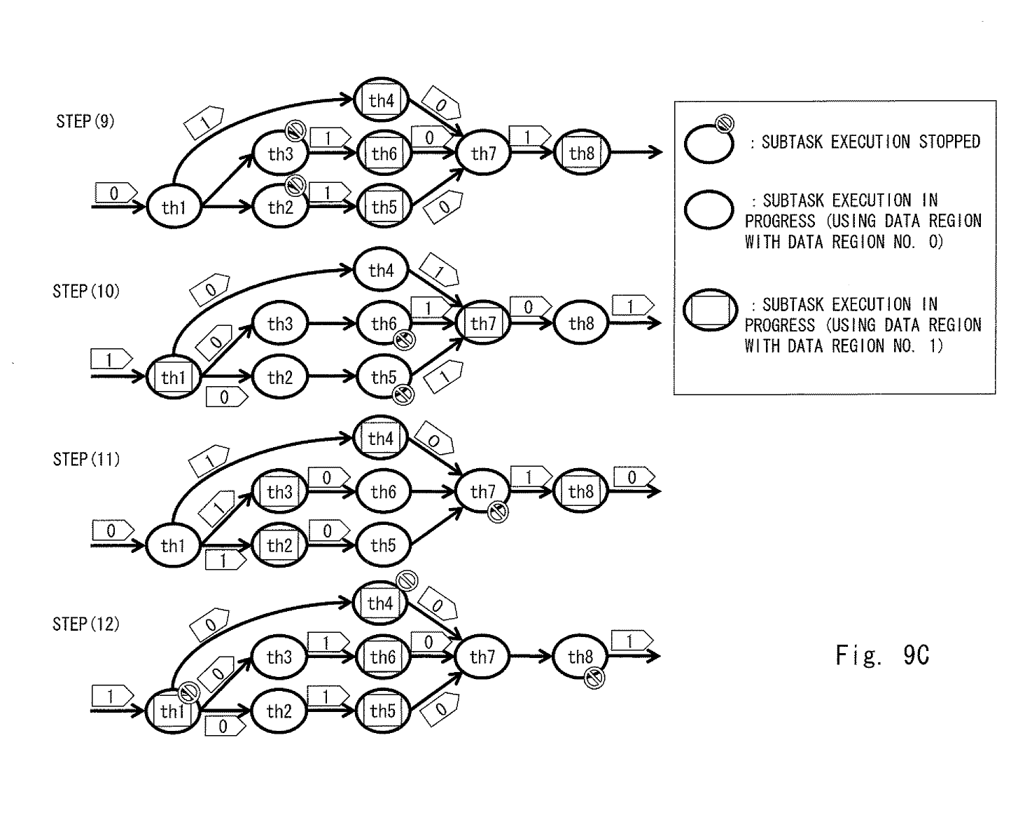

The pipeline parallel operation of threads that can be achieved in this exemplary embodiment is explained with reference to FIGS. 9A, 9B, and 9C. FIGS. 9A, 9B, and 9C are diagrams showing the state in which eight threads identical to those in FIG. 8 operate in pipeline parallel. In FIGS. 9A, 9B, and 9C, the data regions to be used by the threads are alternately switched using the signals in order to operate the threads in parallel. The following explanation is for the state of switching the data regions.

First, steps (1) to (4) in FIG. 9A are explained. In the step (1), the main thread transmits a signal to the thread th1, which is a starting point. At this time, the main thread shall include the data region number 0 in the signal. The thread th1 receives the signal and executes the subtask using the data region with the data region number 0.

Subsequently, in the step (2), the thread th1 transmits the signal (data region number 0) to each of the threads th2, th3, and th4. The threads th2, th3, and th4 each perform respective subtasks using the data region with the data region number 0. Further, the main thread transmits to the thread th1 the signal with the data region number switched from 0 to 1 (data region number 1). The thread th1 receives the signal and executes the subtask using the data region with the data region number 1.

Next, in the step (3), each of the threads th2, th3, and th4 transmits the signal (data region number 0) to each of the threads th5, th6, and th7, respectively. Then, the threads th5 and th6 each execute respective subtasks using the data region with the data region number 0. On the other hand, the thread th7 continues to wait for the signals from the threads th5 and th6. The thread th1 further transmits the signal (data region number 1) to the threads th2, th3, and th4. The thread th2, th3, and th4 each perform respective subtasks using the data region with the data region number 1. The main thread further transmits a signal (data region number 0) to the thread th1. The thread th1 executes the subtask using the data region with the data region number 0.

Subsequently, in the step (4), each of the threads th5 and th6 transmits the signal (data region number 0) to the thread th7. As the thread th7 has received necessary signals, the thread th7 executes the subtask using the data region with the data region number 0. Next, the threads th2, th3, th5, and th6 each perform transmission of the signals, reception of the signals, and execution of the subtasks. The threads th5 and th6 each receive the signal (data region number 1) and execute the subtasks. Moreover, the threads th2 and th3 each receive the signal (data region number 0) and execute the subtasks.

As the thread th7 is still executing the subtask using the data region with the data region number 0, the thread th4 is unable to transmit a new signal (data region number 1) to the thread th7 and is in a waiting state. That is, the thread th7 leaves the reception waiting flag that associates the threads th4 and th7 to 0. When the thread th7 completes the execution of the subtask using the data region with the data region number 0 and enters the state ready to receive the new signal, the thread th4 can transmit the signal (data region number 1) to the thread th7.

In addition, since the thread th4 is in the waiting state, the thread th1 is unable to transmit the signal (data region number 0) to the thread th4. That is, the thread th4 leaves the reception waiting flag of the channel that associates the threads th1 and th4 to 0. The thread th1 waits until the reception waiting flag of the channel associating the threads th1 and th4 is set to 1. Therefore, the thread th1 leaves the reception waiting flag of the channel associating the main thread and the thread th1 to 0.

Below is an explanation of the steps (5) to (8) in FIG. 9B. In the step (5), as the execution of the subtask using the data region with the data region number 0 is completed, the thread th7 is able to receive the new signal (data region number 1) and execute the subtask. Therefore, the thread th7 sets the reception waiting flag of the channels associating each thread th4 to th6 and the thread th7 to 1. Then, the thread th7 receives the signal (data region number 1) from the threads th4 to th6 and executes the subtask. This cancels the waiting state of the thread th4.

The thread th8 receives the signal (data region number 0) from the thread 7 and executes the subtask. Meanwhile, the thread th4 has been in the waiting state in the step (4) and the waiting state thereof is cancelled in the step (5), thus the reception waiting flag of the channel associating the threads th1 and th4 is set to 1. Then, the thread th4 receives the signal (data region number 0) from the thread th1 and executes the subtask. Subsequently, the thread th1 waits until the thread th4 receives the signal (data region number 0), receives the signal (data region number 1) from the main thread, and executes the subtask. The threads th2 and th3 each wait for a new signal (data region number 1) to be transmitted from the thread th1. The threads th5 and th6 each receive the signal (data region number 0) from the threads th2 and th3 respectively and execute the subtasks.

Next, the threads th1, th2, th3, th4, th7, and th8 each perform transmission of the signals, reception of the signals, and execution of the subtasks. The main thread transmits a signal (data region number 0) to the thread th1. The threads th1 and th7 each receive the signal including the data region number 0 and execute the subtasks. The threads th2, th3, th4, and th8 each receive the signal including the data region number 1 and execute the subtasks. Meanwhile, the thread th5 waits for the new signal (data region number 1) to be transmitted from the thread th2, and the thread th6 waits for the new signal (data region number 1) to be transmitted from the thread th3.

Subsequently, in the step (7), the threads other than the thread th7 each perform transmission of the signals (except for the thread th5 and 6), reception of the signals, and execution of the subtasks. That is, the threads th1, th5, and th6 each receive the signal (data region number 1) and execute the subtasks. Moreover, the threads th2, th3, th4, and th8 each receive the signal including the data region number 0 and execute the subtasks. The main thread transmits a signal (data region number 1) to the thread th1. On the other hand, although the thread th7 has received the signal (data region number 1) from the thread th4, the thread th7 waits until the thread th7 can receive the signals from the threads th5 and th6.

Next, in the step (8), the threads other than the thread th1, th4, and th8 each perform transmission of the signals (except for the thread th7), reception of the signals, and execution of the subtasks. That is, the threads th5 and th6 each receive the signal (data region number 0) and execute the subtasks. Further, the threads th2, th3, and th7 each receive the signal (data region number 1) and execute the subtasks. The main thread transmits a signal (data region number 1) to the thread th1. Meanwhile, the thread th8 waits for the new signal to be transmitted from the thread th7, and the threads th1 and th4 are in the same state as the step (4). Specifically, since the thread th7 is executing the subtask using the signal (data region number 1) transmitted previously by the thread th4, the thread th4 is unable to transmit the new signal (data region number 0) to the thread th7 and is in the waiting state. Moreover, the thread th1 is also unable to transmit the signal (data region number 1) to the thread th4. When the thread th7 completes the execution of the subtask using the signal (data region number 1), the thread th4 is able to transmit the signal (data region number 0) to the thread th7.

Below is an explanation of the steps (9) to (12) in FIG. 9C. In the step (9), the thread th7 receives the new signal (data region number 0) and executes the subtask. The thread th8 receives the signal (data region number 1) and executes the subtask. On the other hand, the thread th4 that has been in the waiting state in the step (8) receives the signal (data region number 1) from the thread th1 in the step (9) and executes the subtask. Then, after the thread th1 waits until the thread th4 receives the signal (data region number 1), the thread th1 receives a signal (data region number 0) from the main thread and executes the subtask. In the meantime, the threads th2 and th3 each wait for the new signal (data region number 0) to be transmitted from the thread th1. The thread th5 and th6 each receive the signal (data region number 1) and execute the subtasks.

The step (9) have reversed signal numbers of the step (5) (0 is changed to 1 and 1 is changed to 0). The similar relationship is applied between the step (10) and the step (6), between the step (11) and the step (7), and between the step (12) and the step (8). After the step (12), the process returns to the step (5) and repeats the operation. Therefore, detailed explanation is omitted for the step (10) and subsequent steps. As stated above, this exemplary embodiment enables multiple threads to operate pipeline parallel.

As has been explained before, the present invention enables, in a shared memory environment, multiple threads to share the data in the shared memory and to operate in pipeline parallel without directly transferring the data between the threads by message passing. The present invention can be widely applied to a computer in which multiple threads operate in the shared memory environment such as a built-in multiprocessor and a general-purpose multi-core PC.

As described so far, in this exemplary embodiment, when the first thread that performs the operation and the second thread that performs the operation using the operation result of the first thread, the first thread performs the operation and stores data indicating the operation result to a particular data region among multiple data regions included in the storage unit 10. Next, the first thread transmits to the second thread the signal indicating storage of the data to the storage unit 10. Then, in response to the signal from the first thread, the second thread performs the operation using the data stored to the data region indicated by the data region number included in the signal.

Accordingly, after the first thread stores the data to the storage unit 10, the second thread uses the data stored to the storage unit 10, thus there is no access conflict to the data in the storage unit 10 between the first thread and the second thread. This guarantees exclusive data access without locking/unlocking.

Moreover, the second thread can obtain the operation result of the first thread only by the first thread transmitting to the second thread the information indicating the data region that stores the data. This eliminates the need to transmit the data itself indicating the operation result. Therefore, data transfer cost can be reduced.

Further, in this exemplary embodiment, at a certain step, the first thread performs the operation and stores the data indicating the operation result to the data region 0 included in the storage unit 10. Then, at the next step, while the first thread performs the operation and stores the data indicating the operation result to the data region 1, which is different from the data region 0, the second thread performs the operation using the data stored to the data region 0 indicated by the signal from the first thread.

Accordingly, there is no conflict between use of the data in the data region 0 by the second thread and update of the data in the data region 0 by the first thread. This enables threads to operate in pipeline parallel. Note that this can be applied when the data region 0 and the data region 1 are reversed.

Although the present invention has been explained with reference to the above exemplary embodiment, the present invention is not limited by above. Various modifications that can be understood by a person skilled in the art can be made to the configurations and details of the present invention within the scope of the invention.

In this exemplary embodiment, the thread includes in the signal the data region number indicating the data region storing the data representing the operation result and transmits the signal. Upon receipt of the signal, the thread that depends on the aforementioned thread uses the data stored to the data region with the data region number included in the signal, however it is not limited to this. Specifically, although in this exemplary embodiment, information indicating the region storing the data is included in the information notifying the data storage to the data region and transmitted, such information may not be transmitted as one piece of information.

This exemplary embodiment illustrated the case of alternately transmitting the signal including the data region number 0 and the signal including the data region number 1, however it is not limited to this. For example, the storage unit 10 may include three or more data region numbers and transmits a signal including the data region number greater than or equal to 2. Moreover, this exemplary embodiment illustrated the case in which the main thread cyclically switches the data region number of the signal to transmit, it is not limited to this. The main thread may switch the data region numbers in any way as long as multiple threads do not conflict for using or updating the same data.

Although this exemplary embodiment illustrated the case where one processor executes one thread, it is not limited to this. For example, one processor may perform two or more threads. That is, multiple threads may be executed by any number of processors.

The data processing device according to the present invention described above can be configured in a way that a computer or a processor such as CPU (Central Processing Unit) and MPU (Micro Processing Unit) included in the computer executes a program realizing the functions of the above exemplary embodiment.

Further, this program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Further, it is not limited to the case where the functions of the above exemplary embodiment are realized by the computer or the processor executing the program that realizes the functions of the above exemplary embodiment. The exemplary embodiment of the present invention also includes the case where the functions of the above exemplary embodiment are realized by the cooperation of an OS (Operating System) or application software that operate on the computer or the processor. Furthermore, the exemplary embodiment of the present invention also includes the case where the functions of the above exemplary embodiment are achieved by executing all or a part of the processes of this program using a functionality enhancement unit inserted into the computer or a functionality enhancement unit connected to the computer.

The whole or part of the exemplary embodiments disclosed above can be described as, but not limited to, the following supplementary notes.

(Supplementary note 1) A data processing method for executing a first thread that performs an operation and a second thread that performs an operation using an operation result of the first thread, the data processing method comprising:

a first operation step, by the first thread, that performs the operation and stores data indicating the operation result of the operation to a particular region among a plurality of regions included in the storage unit;

a transmission step, by the first thread, that transmits storage notification information and storage region information to the second thread, the storage notification information notifying data storage to the storage unit and the storage region information indicating the region in the storage unit that stores the data; and

a second operation step that, in response to the storage notification information from the first thread, performs an operation using the data stored to the region indicated by the storage region information from the first thread.

(Supplementary note 2) The data processing method according to Supplementary note 1, wherein

in the first operation step, the first thread performs a first operation and stores first data indicating a result of the first operation to a first region included in the storage unit,

in the second operation step, the first thread performs a second operation and stores second data indicating a result of the second operation to a second region included in the storage unit that is different from the first region while the second thread performs the operation using the first data stored to the first region indicated by the storage region information from the first thread.

(Supplementary note 3) The data processing method according to Supplementary note 2, wherein

the data processing method is a data processing method for further executing a main thread,

the main thread further includes a step for transmitting the storage region information indicating the first region to the first thread,

in the first operation step, the first thread stores the first data to the first region indicated by the storage region information from the main thread,

in the transmission thread, the main thread transmits the storage region information indicating the second region to the first thread, and

in the second operation step, the first thread stores the second data to the second region indicated by the storage region information from the main thread.

(Supplementary note 4) The data processing method according to any one of Supplementary notes 1 to 3, wherein

the data processing method executes a plurality of the first threads,

the second thread performs an operation using a plurality of operation results by the plurality of first threads,

the transmission step includes a step, when the first thread transmits the storage notification information and the storage region information to the second thread, for storing transmission execution information indicating the transmission of the storage notification information and the storage region information to a transmission and reception information storage unit corresponding to the first thread, and a step, when the transmission execution information is stored to the transmission and reception information storage unit, for receiving, by the second thread, receiving the storage notification information and the storage region information from the first thread corresponding to the transmission and reception information storage unit,

in the second operation step, when the second thread receives all the storage notification information from the plurality of first threads, the second thread performs the operation using the data stored to the region indicated by the storage region information from the first thread.

(Supplementary note 5) The data processing method according to Supplementary note 4, wherein

in the step for storing the transmission execution information, the first thread stores the storage notification information and the storage region information to the transmission and reception information storage unit and the transmission execution information to the transmission and reception information storage unit,

in the step for receiving the storage region information, when the transmission execution information is stored to the transmission and reception information storage unit, the second thread obtains the storage notification information and the storage region information stored to the transmission and reception information storage unit.

(Supplementary note 6) The data processing method according to any one of Supplementary notes 1 to 5, wherein

the region included in the storage unit each stores the data and includes a plurality of data storage regions including a first data storage region and a second storage region,

in the first operation step, the first thread stores the data to the first data storage region included in the particular region,

in the second operation step, the second thread stores data indicating the operation result to the second data storage region included in the region indicated by the storage region information from the first thread.

(Supplementary note 7) The data processing method according to any one of Supplementary notes 1 to 6, wherein the storage notification information includes the storage region information.
(Supplementary note 8) The data processing method according to any one of Supplementary notes 1 to 7, wherein the first thread and the second threads are executed by one or more processors.
(Supplementary note 9) A data processing device comprising:

a storage unit that includes a plurality of regions for storing data; and

an execution unit that executes a first thread for performing an operation and a second thread that performs an operation using an operation result of the first thread, wherein

the first thread performs the operation and stores data indicating the operation result to a particular region among the plurality of regions included in the storage unit, transmits to the second thread storage notification information for notifying storage of the data to the storage unit and storage region information indicating the region storing the data, and

the second thread, in response to the storage notification information from the first thread, performs the operation using the data stored to the region indicated by the storage region information from the first thread.

(Supplementary note 10) A data processing program for causing a processor to execute a data processing method for executing a first thread that performs an operation and a second thread that performs an operation using an operation result of the first thread, the data processing method comprising:

a first operation step, by the first thread, that performs the operation and stores data indicating the operation result of the operation to a particular region among a plurality of regions included in the storage unit;

a transmission step, by the first thread, that transmits storage notification information and storage region information to the second thread, the storage notification information notifying data storage to the storage unit and the storage region information indicating the region in the storage unit that stores the data; and

a second operation step that, in response to the storage notification information from the first thread, performs an operation using the data stored to the region indicated by the storage region information from the first thread.

The present application claims priority rights of and is based on Japanese Patent Application No. 2010-229784 filed on Oct. 12, 2010 in the Japanese Patent Office, the entire contents of which are hereby incorporated by reference.

### REFERENCE SIGNS LIST

1, 5 DATA PROCESSING DEVICE
10 STORAGE UNIT
11, 12, 13, 14, 15, 16, 17, 18 PROCESSOR
50 STORAGE UNIT
51 EXECUTION UNIT
52, 53, th1, th2, th3, th4, th5, th6, th7, th8 THREAD

1. A data processing method comprising executing a third thread for performing a series of procedures (reception, operation, storage, and transmission), the series of procedures including receiving a control signal transmitted from a first thread that supplies input data, then executing an operation using the input data, storing a result of the operation to a data region specified by the control signal, and transmitting the control signal to a second thread that uses the result.

2. The data processing method according to claim 1, wherein
the first thread and the second threads are different threads from each other, and
either one of series of procedures is performed, the one series of procedures (reception, operation, storage, and transmission) including receiving a control signal transmitted from a thread that supplies the first thread with input data, then executing an operation using the input data, storing a result of the operation to a data region specified by the control signal as input data to be supplied to the third thread, and transmitting the control signal to the third thread, and the other series of procedures (reception, operation, storage, and transmission) including the second thread receiving a control signal transmitted from the third thread, then executing an operation using a result of the operation stored to a data region specified by the control signal, storing a result of the operation to the data region specified by the control signal, and transmitting the control signal to a thread that uses the result.

3. The data processing method according to claim 2, wherein the third thread waits until the second thread receives the control signal at the time of transmitting the control signal.

4. The data processing method according to claim 3, wherein the third thread writes the result of the operation to at least two data regions by the first thread switching a value of the control signal to be transmitted to the third thread.

5. A data processing device comprising:
storage unit includes a data region for storing data; and
execution unit executes a third thread for performing a series of procedures (reception, operation, storage, and transmission), the series of procedures including receiving a control signal transmitted from a first thread that supplies input data, then executing an operation using the input data, storing a result of the operation to a data region specified by the control signal, and transmitting the control signal to a second thread that uses the result.

6. A non-transitory computer readable medium storing a data processing program that operates a computer including a data region for storing data as means to execute a third thread for performing a series of procedures (reception, operation, storage, and transmission), the series of procedures including receiving a control signal transmitted from a first thread that supplies input data, then executing an operation using the input data, storing a result of the operation to a data region specified by the control signal, and transmitting the control signal to a second thread that uses the result.
